(19) United States
(12) Patent Application Publication
(10) Pub. No.: US 2013/0166086 A1
(43) Pub. Date: Jun. 27, 2013

(54) Systems and devices for transformation and distribution of energy storage devices

(71) Applicant: Jason Rugolo, Scottsdale, AZ (US)

(72) Inventor: Jason Rugolo, Scottsdale, AZ (US)

(73) Assignee: earthCell, Inc., Oakland, CA (US)

(21) Appl. No.: 13/573,796

(22) Filed: Oct. 3, 2012

Related U.S. Application Data
(60) Provisional application No. 61/542,696, filed on Oct. 3, 2011.

(51) Int. Cl. G06F 1/26

(52) U.S. Cl. CPC G06F 1/26
USPC 700/295

(57) ABSTRACT

Disclosed herein are methods and system for managing distribution and transformation of energy storage devices. Also provided are computer-implemented methods for managing the distribution and transformation of energy storage devices. Also provided are distribution units for receipt and dispensation of energy storage devices; and charging units to transform energy storage devices to substantially charged state.

### CROSS-REFERENCE TO RELATED APPLICATION

The present application is a non-provisional application which claims priority to U.S. Provisional Patent Application No. 61/542,696, filed Oct. 3, 2011; all of which is herein incorporated by reference in its entirety.

### FIELD OF INVENTION

This invention relates to systems and methods for managing distribution, and transformation of energy storage devices. Charging units to transform energy storage devices from substantially uncharged to substantially charged state are provided herein. Also provided are distribution units for dispensation and receipt of energy storage devices.

### BACKGROUND OF THE INVENTION

Energy storage devices such as electrochemical cells store energy well and for a considerable length of time. Primary electrochemical cells are non-rechargeable, hence need to be discarded when the stored energy is depleted, and the cell is transformed from a charged state to an uncharged state. Certain rechargeable electrochemical cells maintain their capacity at high discharge rates, and can be periodically recharged to transform into a substantially charged state.

### SUMMARY OF THE INVENTION

Disclosed herein are methods and system for managing distribution and transformation of energy storage devices. Also provided are computer-implemented methods for managing the distribution and transformation of energy storage devices. Also provided are distribution units for receiving energy storage devices from a sender user, and dispensing energy storage devices to a recipient user; and charging units to transform energy storage devices from substantially uncharged to substantially charged state.

Provided herein are systems for managing distribution and transformation of energy storage devices. In certain embodiments is a system for managing distribution and transformation of energy storage devices, wherein said system comprises at least one distribution unit useful to: receive energy storage devices from a sender user, dispense substantially charged energy storage devices to a recipient user, or both; at least one charging unit for transforming energy storage devices from a substantially uncharged state to a substantially charged state; at least one processing unit; and at least one sequence of program instructions stored in an electronic digital memory in said processing unit, which when executed cause at least one step selected from transformation, inventory, storage, and dispensation of energy storage devices. In certain embodiments, the charging unit is contained within the distribution unit. In select embodiments, the processing unit is contained within the distribution unit. In some embodiments, the processing unit is a computer. In certain embodiments, the processing unit is a computer placed within the distribution unit.

Provided are systems for managing distribution and transformation of energy storage devices, wherein transformation of the energy storage devices is performed by providing by means of a charging unit, electricity in an amount sufficient to transform said energy storage devices to a substantially charged state. In certain embodiments, the charging unit provides electricity sufficient to transform the energy storage device from a substantially uncharged state to a substantially charged state.

Certain embodiments of the systems described herein comprise at least one charging unit for transforming energy storage devices from a substantially uncharged state to a substantially charged state, wherein said charging unit can simultaneously charge a plurality of energy storage devices by transforming said devices from a substantially uncharged state to a substantially charged state. In certain embodiments, provided are charging units that maintain substantially charged energy storage devices in said substantially charged state. In some embodiments, the charging unit can simultaneously charge at least 10 energy storage devices. In an embodiment is a charging unit that can simultaneously charge at least 20 energy storage devices. In certain embodiments are charging units that can simultaneously charge at least 50 energy storage devices. In an embodiment provided is a charging unit that can simultaneously charge at least 100 energy storage devices. In some embodiments are charging units that can simultaneously charge at least 1000 energy storage devices. In some embodiments, are charging units that can simultaneously charge at least 10000 energy storage devices. In certain embodiments are charging units that can charge at least 100000 energy storage devices. In certain embodiments, a plurality of charging units are simultaneously provided in a system described herein. In a further embodiment, at least 5 charging units are simultaneously provided in a system described herein. In certain embodiments, 10 charging units are deployed simultaneously to charge a high plurality of energy storage devices. In an embodiment, 50 charging units are provided. In a further embodiment, at least 100 charging units are provided. In some embodiments, at least 1000 charging units that can simultaneously charge between 10 and 100000 energy storage devices are provided in systems described herein. In certain embodiments, at least one charging unit is contained within a distribution unit described herein. In certain embodiments, the charging unit is separate from the distribution unit, and energy storage devices are transported between the distribution unit and the charging unit by means of a delivery service. In certain embodiments, the delivery service is a courier service.

Provided are systems for managing distribution and transformation of energy storage devices, wherein transformation of the energy storage devices is performed by providing electricity in an amount sufficient to transform said energy storage devices to a substantially charged state, and wherein the system regulates the supply of electricity to the energy storage devices. In an embodiment, the regulation further comprises prevention of overcharging charged energy storage devices. In some embodiments, the system regulates the supply of energy by performing hysteresis charging prior to constant voltage charging. In certain embodiments, the system regulates the supply of electricity so as to minimize charging during peak hours.

Provided are systems for managing distribution and transformation of energy storage devices, wherein transformation of the energy storage devices is performed by providing electricity in an amount sufficient to transform said energy storage devices from a substantially uncharged state to a substantially charged state, and wherein at least some of the electricity is obtained from a renewable source. In certain embodiments, the renewable source of electricity is solar. In certain embodiments, the renewable source of electricity is biomass, bio-fuel, geothermal, tidal, hydroelectric, wind, solar or combinations thereof.

Provided are systems for managing distribution and transformation of energy storage devices, wherein said energy storage devices are electrochemical cells. In certain embodiments, the electrochemical cell is a rechargeable electrochemical cell. In some embodiments, the electrochemical cell is a secondary electrochemical cell. In certain embodiments, the electrochemical cells have a power-to-weight ratio of about 50 to about 25000 W/kg. In certain embodiments, the electrochemical cells transformed and distributed by the systems described herein, are not automobile traction batteries. In some embodiments, the electrochemical cells transformed and distributed by the systems described herein, are not electric vehicle batteries.

In some embodiments, the electrochemical cells useful in the systems, and methods described herein are low self-discharge cells. In certain embodiments, the rechargeable electrochemical cells are alkaline cells. In certain embodiments, the rechargeable electrochemical cells are one or more of nickel-metal hydride cells, nickel-iron cells, nickel-cadmium cells, nickel-hydrogen cells, nickel-zinc cells, lithium ion cells, lithium polymer cells, lithium-iron-phosphate cells, lithium-sulfur cells, lithium-titanate cells, thin film lithium cells, zinc bromide cells, silver oxide cells, silver-zinc cells, vanadium redox cells, sodium-sulfur cells, molten salt cells and combinations thereof. In some embodiments, the rechargeable electrochemical cells are molten salt cells such as sodium-sulfur cells, lithium-sulfur cells, sodium-aluminum chloride cells or combinations thereof.

Provided herein is a system for managing distribution and transformation of energy storage devices, wherein said system comprises at least one distribution unit useful to receive energy storage devices from a sender user, dispense substantially charged energy storage devices to a recipient user, or both; at least one unit for transforming said substantially uncharged energy storage devices into component materials; at least one processing device; at least one sequence of computer program instructions stored in an electronic digital memory in said processing device, which when executed cause at least one step selected from transformation, inventory, storage and dispensation of energy storage devices. In certain embodiments, the energy storage devices are electrochemical cells. In some embodiments, the electrochemical cell is non-rechargeable. In some embodiments, the electrochemical cell is a primary cell. In an embodiment, the electrochemical cell is a non-rechargeable alkaline cell. In an embodiment, the electrochemical cell is a non-rechargeable zinc-carbon cell, zinc-chloride cell, Oxy-nickel cell, lithium-copper oxide cell, lithium-iron disulfide cell, lithium-manganese dioxide cell, mercury oxide cell, silver oxide cell, silver-zinc cell, zinc-air cell or combinations thereof. In certain embodiments, the transforming unit is separate from the distribution unit, and energy storage devices are transported from the distribution unit to the transformation unit by means of a delivery service. In some embodiments, the delivery service is a courier service.

In certain embodiments of the systems described herein, the system comprises a distribution unit, and said distribution unit comprises: a receiver panel useful to receive at least one energy storage device from a sender user; a selection panel that enables a recipient user to select size, type and number of energy storage devices to be dispensed; a transaction panel useful to process payment from said recipient user; a dispensation panel useful to dispense to said recipient user, substantially charged energy storage devices as selected by the recipient user; and a control panel, said panel useful at least for restocking and organizing energy storage devices within said distribution unit.

Provided herein are methods of managing distribution and transformation of energy storage devices. In an embodiment is a computer-implemented method of managing distribution and transformation of energy storage devices, wherein said method comprises receiving substantially uncharged energy storage devices; transforming energy storage devices from a substantially uncharged state to a substantially charged state; transacting payment from a recipient user for substantially charged energy storage devices selected by said user; dispensing charged energy storage devices to said recipient user; utilizing at least one sequence of computer program instructions stored in an electronic digital memory in a computer to manage at least one step selected from organization, transformation, inventory, storage, payment transaction and dispensation of energy storage devices.

In an embodiment is a method wherein transformation of the energy storage devices is performed by providing electricity in an amount sufficient to transform said energy storage devices from a substantially uncharged state to a substantially charged state. In certain embodiments, the method further comprises maintaining substantially charged energy storage devices in said substantially charged state. In certain embodiments the method further comprises regulating the supply of electricity to the energy storage devices. In some embodiments, the regulation further comprises prevention of overcharging charged energy storage devices.

Provided is a method of managing distribution and transformation of energy storage devices, wherein said method comprises receiving energy storage devices from a sender user; transforming said energy storage devices into isolated component materials; transacting payment from a recipient user for substantially charged energy storage devices selected by said user; dispensing charged energy storage devices to said recipient user; utilizing at least one sequence of computer program instructions stored in an electronic digital memory in a computer to manage at least one step selected from organization, transformation, inventory, storage, payment transaction and dispensation of energy storage devices. In certain embodiments, at least one of receiving and dispensation of energy storage devices is performed by use of a distribution unit. In some embodiments, the delivery service is a mail delivery service. In certain embodiments, the delivery service is a courier service. In certain embodiments, the delivery service is an express mail service.

Provided herein is a distribution unit for receiving, and dispensing energy storage devices, said unit comprising a receiver panel useful to receive at least one energy storage device from a sender user; a selection panel that enables a recipient user to select size, type and number of energy storage devices to be dispensed; a transaction panel useful to process payment from said recipient user; a dispensation panel useful to dispense to said recipient user, substantially charged energy storage devices as selected by the recipient user; and a control panel, said panel useful at least for restocking and organizing energy storage devices within said distribution unit.

In certain embodiments, the distribution unit further comprises a charging unit for transforming energy storage devices from a substantially uncharged state to a substantially charged state. In some embodiments, transformation of the energy storage devices is performed by providing electricity in an amount sufficient to transform said energy storage devices from a substantially uncharged state to a substantially charged state. In a further embodiment, the charging unit can simultaneously charge a plurality of energy storage devices by transforming said devices from a substantially uncharged state to a substantially charged state. In an embodiment, the charging unit maintains substantially charged energy storage devices in said substantially charged state till said devices are dispensed to a recipient user. In an embodiment, the charging unit can simultaneously charge at least 10 energy storage devices. In some embodiments, the charging unit can simultaneously charge at least 20 energy storage devices. In some embodiments, the charging unit can simultaneously charge at least 50 energy storage devices. In an embodiment, the charging unit can simultaneously charge at least 100 energy storage devices. In certain embodiments, the charging unit can simultaneously charge at least 1000 energy storage devices.

In certain embodiments, the charging unit regulates the supply of energy to the energy storage devices. In further embodiments, the regulation further comprises prevention of overcharging of charged energy storage devices. In some embodiments is a charging unit wherein at least some of the electricity is obtained from a renewable source. In an embodiment, all of the electricity is obtained from a renewable source. In some embodiments, the renewable source of electricity is solar. In an embodiment, the renewable source of electricity is biomass, biofuel, geothermal, tidal, hydroelectric, wind, solar or combinations thereof. In certain embodiments is provided a distribution unit which further comprises a charging unit that regulates the supply of electricity so as to minimize charging during peak hours. In some embodiments of the distribution unit described herein, the energy storage device is an electrochemical cell. In some embodiments, the electrochemical cell is rechargeable. In certain further embodiments, the electrochemical cells are not traction batteries. In some specific embodiments, the electrochemical cells are not electric vehicle batteries.

Provided is a distribution unit as described herein, wherein said distribution unit further comprises at least one panel for secure placement of energy storage devices. In some embodiments, the at least one panel for secure placement of energy storage devices comprises a lining comprising an insulator material such that said material helps avoid the dissipation of charge in the energy storage device. In certain embodiments, the at least one panel for secure placement of energy storage devices can be detached from the distribution unit. In some embodiments, the at least one panel for secure placement of energy storage devices can be connected to a source of energy that provides an amount of energy to transform said at least one energy storage device from a substantially uncharged state to a substantially charged state.

In certain embodiments provided is a distribution unit for receiving energy storage devices, said unit comprising: a receiver panel useful to receive at least one energy storage device from a sender user; a selection panel that enables said sender user to select transaction options; a transaction panel useful to process said transaction; and a control panel, said panel useful at least for removing energy storage devices within said distribution unit.

Provided is a distribution unit as described herein, wherein said distribution unit comprises a selection panel that comprises at least one display screen. In some embodiments, the display screen is a touchscreen. In an embodiment, the selection panel comprises at least one keyboard.

Provided is a distribution unit as described herein, wherein said distribution unit comprises a transaction panel that comprises at least one bill acceptor and at least one coin acceptor to accept currency bills and coins from a recipient user. In certain embodiments, the bill acceptor further comprises a mechanism to identify the bill and return any unacceptable bill. In some embodiments, the coin acceptor further comprises a mechanism to identify the coin and return any unacceptable coins. In an embodiment, the transaction panel further comprises a change panel to return appropriate change to the recipient user. In another embodiment, the transaction panel comprises at least one panel to facilitate an electronic transaction. In a further embodiment, the panel to facilitate electronic transaction comprises a magnetic strip reader. In certain embodiments, the panel to facilitate electronic transaction comprises a contactless card reader. In an embodiment, the contactless card is a RFID card. In some embodiments, the contactless card is a resonance inductive coupling powered card. In another embodiment, the contactless card is ISO/IEC 14443 card.

Provided is a distribution unit as described herein, wherein said distribution unit holds a plurality of multiple types of energy storage devices. In certain embodiments, the distribution unit further comprising a mechanism to issue an alert. In some embodiments, the alert mechanism is triggered when at least one energy storage device cannot be transformed to a substantially charged state. In certain embodiments, the alert is activated when a majority of energy storage devices are removed from said device. In an embodiment, the alert is activated when a payment cannot be processed. In some embodiments, the alert is activated when the device is unable to dispense appropriate change in the change panel.

Provided is a distribution unit as described herein, wherein said distribution unit comprises a control panel providing access for restocking and servicing. In certain embodiments, the control panel further comprises a key-less locking panel.

Provided is a distribution unit as described herein, wherein said distribution unit further comprises a scanner that can read a barcode. In certain embodiments, the barcode is a matrix barcode. In a further embodiment, the matrix barcode is a quick response code.

Provided is a method of using a distribution unit described herein for efficiently recycling energy storage devices, said method comprising: receiving at least one energy storage device in a substantially uncharged state; transforming said energy storage device from a substantially uncharged state to a substantially charged state; dispensing said substantially charged energy storage device to a user. In certain embodiments, the energy storage device is an electrochemical cell. In a further embodiment, the electrochemical cell is rechargeable.

Provided is a system for managing distribution and transformation of energy storage devices, wherein said system comprises at least one distribution unit useful to: receive energy storage devices from a sender user, dispense substantially charged energy storage devices to a recipient user, or both; at least one transformation unit for transformation of energy storage devices, said transformation selected from: transformation of substantially uncharged energy storage devices to a substantially charged state by providing a sufficient amount of electricity; and transformation of energy storage devices into component materials; at least one processing unit which is optionally a computer; and at least one sequence of program instructions stored in an electronic digital memory in said processing unit, which when executed cause at least one step selected from transformation, inventory, storage, and dispensation of energy storage devices.

Other aspects and features of the present invention will become apparent to those ordinarily skilled in the art upon review of the following description of specific embodiments of the invention.

### BRIEF DESCRIPTION OF THE FIGURES

FIG. 1 shows a flowchart depicting a method of managing distribution and transformation of energy storage devices

FIG. 2 shows an embodiment of a charging unit used to transform energy storage devices 2 from a substantially uncharged state to a substantially charged state.

FIG. 3 shows two views of an embodiment of a distribution unit described herein.

FIG. 4 shows an embodiment of a distribution unit further comprising a charging unit contained within said distribution unit.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

### DETAILED DESCRIPTION OF THE INVENTION

Provided herein are systems for managing distribution and transformation of energy storage devices. In certain embodiments is a system for managing distribution and transformation of energy storage devices, wherein said system comprises: at least one distribution unit useful to: receive energy storage devices from a sender user, dispense substantially charged energy storage devices to a recipient user, or both; at least one charging unit for transforming energy storage devices from a substantially uncharged state to a substantially charged state; at least one processing unit; and at least one sequence of program instructions stored in an electronic digital memory in said processing unit, which when executed cause at least one step selected from transformation, inventory, storage, and dispensation of energy storage devices. In certain embodiments, the processing device is a computer.

In general the following words and phrases have the indicated definitions when used in the description, examples and claims.

### Systems

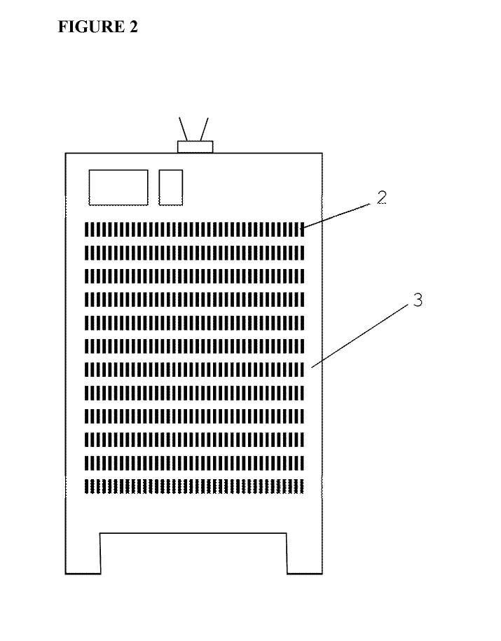

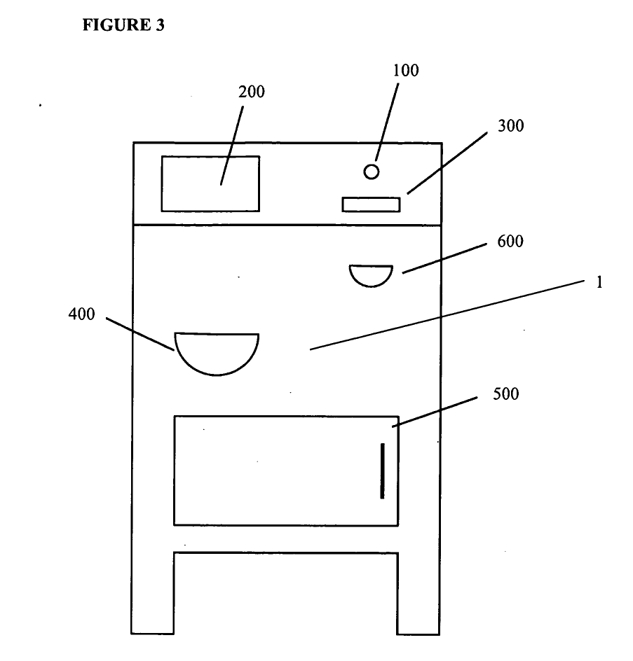

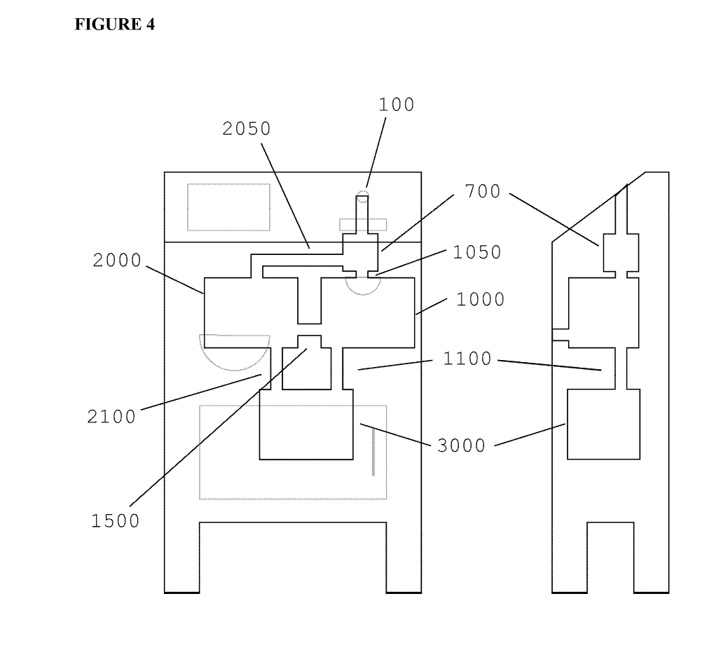

Provided herein are systems for managing distribution and transformation of energy storage devices. In certain embodiments is a system for managing distribution and transformation of energy storage devices, wherein said system comprises at least one distribution unit (such as, but not restricted to the unit shown in FIG. 3) useful to: receive energy storage devices from a sender user, dispense substantially charged energy storage devices to a recipient user, or both; at least one charging unit (such as, but not restricted to the unit shown in FIG. 2) for transforming energy storage devices from a substantially uncharged state to a substantially charged state; at least one processing unit; and at least one sequence of program instructions stored in an electronic digital memory in said processing unit, which when executed cause at least one step selected from transformation, inventory, storage, and dispensation of energy storage devices. In certain embodiments, the charging unit is contained within the distribution unit (such as, but not restricted to the embodiment shown in FIG. 4). In select embodiments, the processing unit is contained within the distribution unit. In some embodiments, the processing unit is a computer. In certain embodiments, the processing unit is a computer placed within the distribution unit.

Provided are systems for managing distribution and transformation of energy storage devices, wherein transformation of the energy storage devices is performed by providing by means of a charging unit, electricity in an amount sufficient to transform said energy storage devices to a substantially charged state. In certain embodiments, the charging unit provides electricity sufficient to transform the energy storage device from a substantially uncharged state to a substantially charged state.

Certain embodiments of the systems described herein comprise at least one charging unit for transforming energy storage devices from a substantially uncharged state to a substantially charged state, wherein said charging unit can simultaneously charge a plurality of energy storage devices by transforming said devices from a substantially uncharged state to a substantially charged state. In certain embodiments, provided are charging units that maintain substantially charged energy storage devices in said substantially charged state. In some embodiments, the charging unit can simultaneously charge at least 10 energy storage devices. In an embodiment is a charging unit that can simultaneously charge at least 20 energy storage devices. In certain embodiments are charging units that can simultaneously charge at least 50 energy storage devices. In an embodiment provided is a charging unit that can simultaneously charge at least 100 energy storage devices. In some embodiments are charging units that can simultaneously charge at least 1000 energy storage devices. In some embodiments, are charging units that can simultaneously charge at least 10000 energy storage devices. In certain embodiments are charging units that can charge at least 100000 energy storage devices. In certain embodiments, a plurality of charging units are simultaneously provided in a system described herein. In a further embodiment, at least 5 charging units are simultaneously provided in a system described herein. In certain embodiments, 10 charging units are deployed simultaneously to charge a high plurality of energy storage devices. In an embodiment, 50 charging units are provided. In a further embodiment, at least 100 charging units are provided. In some embodiments, at least 1000 charging units that can simultaneously charge between 10 and 100000 energy storage devices are provided in systems described herein. In certain embodiments, at least one charging unit is contained within a distribution unit described herein. In certain embodiments, the charging unit is separate from the distribution unit, and energy storage devices are transported between the distribution unit and the charging unit by means of a delivery service. In certain embodiments, the delivery service is a courier service.

Provided are systems for managing distribution and transformation of energy storage devices, wherein transformation of the energy storage devices is performed by providing electricity in an amount sufficient to transform said energy storage devices to a substantially charged state, and wherein the system regulates the supply of electricity to the energy storage devices. In an embodiment, the regulation further comprises prevention of overcharging charged energy storage devices. In some embodiments, the system regulates the supply of energy by performing hysteresis charging prior to constant voltage charging. In certain embodiments, the system regulates the supply of electricity so as to minimize charging during peak hours.

Provided are systems for managing distribution and transformation of energy storage devices, wherein transformation of the energy storage devices is performed by providing electricity in an amount sufficient to transform said energy storage devices from a substantially uncharged state to a substantially charged state, and wherein at least some of the electricity is obtained from a renewable source. In certain embodiments, the renewable source of electricity is solar. In certain embodiments, the renewable source of electricity is biomass, bio-fuel, geothermal, tidal, hydroelectric, wind, solar or combinations thereof.

Provided are systems for managing distribution and transformation of energy storage devices, wherein said energy storage devices are electrochemical cells. In certain embodiments, the electrochemical cell is a rechargeable electrochemical cell. In some embodiments, the electrochemical cell is a secondary electrochemical cell. In certain embodiments, the electrochemical cells have a power-to-weight ratio of about 50 to about 25000 W/kg. In certain embodiments, the electrochemical cells transformed and distributed by the systems described herein, are not automobile traction batteries. In some embodiments, the electrochemical cells transformed and distributed by the systems described herein, are not electric vehicle batteries.

In some embodiments, the electrochemical cells useful in the systems, and methods described herein are low self-discharge cells. In certain embodiments, the rechargeable electrochemical cells are alkaline cells. In certain embodiments, the rechargeable electrochemical cells are one or more of nickel-metal hydride cells, nickel-iron cells, nickel-cadmium cells, nickel-hydrogen cells, nickel-zinc cells, lithium ion cells, lithium polymer cells, lithium-iron-phosphate cells, lithium-sulfur cells, lithium-titanate cells, thin film lithium cells, zinc bromide cells, silver oxide cells, silver-zinc cells, vanadium redox cells, sodium-sulfur cells, molten salt cells and combinations thereof. In some embodiments, the rechargeable electrochemical cells are molten salt cells such as sodium-sulfur cells, lithium-sulfur cells, sodium-aluminum chloride cells or combinations thereof.

Provided herein is a system for managing distribution and transformation of energy storage devices, wherein said system comprises at least one distribution unit useful to receive energy storage devices from a sender user, dispense substantially charged energy storage devices to a recipient user, or both; at least one unit for transforming said substantially uncharged energy storage devices into component materials; at least one processing device; at least one sequence of computer program instructions stored in an electronic digital memory in said processing device, which when executed cause at least one step selected from transformation, inventory, storage and dispensation of energy storage devices. In certain embodiments, the energy storage devices are electrochemical cells. In some embodiments, the electrochemical cell is non-rechargeable. In some embodiments, the electrochemical cell is a primary cell. In an embodiment, the electrochemical cell is a non-rechargeable alkaline cell. In an embodiment, the electrochemical cell is a non-rechargeable zinc-carbon cell, zinc-chloride cell, Oxy-nickel cell, lithium-copper oxide cell, lithium-iron disulfide cell, lithium-manganese dioxide cell, mercury oxide cell, silver oxide cell, silver-zinc cell, zinc-air cell or combinations thereof. In certain embodiments, the transforming unit is separate from the distribution unit, and energy storage devices are transported from the distribution unit to the transformation unit by means of a delivery service. In some embodiments, the delivery service is a courier service.

In certain embodiments of the systems described herein, the system comprises a distribution unit, and said distribution unit comprises: a receiver panel useful to receive at least one energy storage device from a sender user; a selection panel that enables a recipient user to select size, type and number of energy storage devices to be dispensed; a transaction panel useful to process payment from said recipient user; a dispensation panel useful to dispense to said recipient user, substantially charged energy storage devices as selected by the recipient user; and a control panel, said panel useful at least for restocking and organizing energy storage devices within said distribution unit.

Provided herein are methods of managing distribution and transformation of energy storage devices. In an embodiment is a computer-implemented method of managing distribution and transformation of energy storage devices, wherein said method comprises receiving substantially uncharged energy storage devices; transforming energy storage devices from a substantially uncharged state to a substantially charged state; transacting payment from a recipient user for substantially charged energy storage devices selected by said user; dispensing charged energy storage devices to said recipient user; utilizing at least one sequence of computer program instructions stored in an electronic digital memory in a computer to manage at least one step selected from organization, transformation, inventory, storage, payment transaction and dispensation of energy storage devices.

In an embodiment is a method wherein transformation of the energy storage devices is performed by providing electricity in an amount sufficient to transform said energy storage devices from a substantially uncharged state to a substantially charged state. In certain embodiments, the method further comprises maintaining substantially charged energy storage devices in said substantially charged state. In certain embodiments the method further comprises regulating the supply of electricity to the energy storage devices. In some embodiments, the regulation further comprises prevention of overcharging charged energy storage devices.

Provided is a method of managing distribution and transformation of energy storage devices, wherein said method comprises receiving energy storage devices from a sender user; transforming said energy storage devices into isolated component materials; transacting payment from a recipient user for substantially charged energy storage devices selected by said user; dispensing charged energy storage devices to said recipient user; utilizing at least one sequence of computer program instructions stored in an electronic digital memory in a computer to manage at least one step selected from organization, transformation, inventory, storage, payment transaction and dispensation of energy storage devices. In certain embodiments, at least one of receiving and dispensation of energy storage devices is performed by use of a distribution unit. In some embodiments, the delivery service is a mail delivery service. In certain embodiments, the delivery service is a courier service. In certain embodiments, the delivery service is an express mail service.

### Energy Storage Device:

“Energy storage device” means any device that is capable of storing or producing electrical energy. In certain embodiments, the energy storage device is an electrochemical cell that can convert stored chemical energy into electrical energy.

In some embodiments, the electrochemical cells are primary cells wherein the electrochemical reaction that converts stored chemical energy into electrical energy is irreversible. Hence, these cells once used, cannot be transformed from substantially uncharged state to substantially charged state (non-rechargeable cells). In an embodiment, the non-rechargeable cell is a non-rechargeable alkaline cell. In some embodiments, the non-rechargeable cell is a non-rechargeable zinc-carbon cell, zinc-chloride cell, Oxy-nickel cell, lithium-copper oxide cell, lithium-iron disulfide cell, lithium-manganese dioxide cell, mercury oxide cell, silver oxide cell, silver-zinc cell, zinc-air cell or combinations thereof.

In some embodiments, the electrochemical cell is a secondary cell, also referred to as a rechargeable cell or a storage cell. In these cells, the electrochemical reactions are electrically reversible. Hence, these cells can be transformed from a substantially uncharged state to a substantially charged state by means of a charging unit. In certain embodiments, the rechargeable electrochemical cells are alkaline cells. In certain embodiments, the rechargeable electrochemical cells are one or more of nickel-metal hydride cells, nickel-iron cells, nickel-cadmium cells, nickel-hydrogen cells, nickel-zinc cells, lithium ion cells, lithium polymer cells, lithium-iron-phosphate cells, lithium-sulfur cells, lithium-titanate cells, thin film lithium cells, zinc bromide cells, silver oxide cells, silver-zinc cells, vanadium redox cells, sodium-sulfur cells, molten salt cells and combinations thereof. In some embodiments, the rechargeable electrochemical cells are molten salt cells such as sodium-sulfur cells, lithium-sulfur cells, sodium-aluminum chloride cells or combinations thereof.

In certain embodiments, the electrochemical cells have a power-to-weight ratio of about 50 to about 25000 W/kg. In some embodiments, the electrochemical cells are low self-discharge cells. In certain embodiments, the electrochemical cells have specific energy of 0.05-3.0 MJ/Kg. In an embodiment, the electrochemical cells have specific energy of 0.1-0.2 MJ/Kg. In certain embodiments, the electrochemical cells have specific energy of 0.1-0.5 MJ/Kg. In certain embodiments, the electrochemical cells have specific energy of 0.5-1.5 MJ/Kg. In some embodiments, the electrochemical cells provided herein have a nominal cell voltage of 0.5-10V. In an embodiment, the electrochemical cells provided herein have a nominal cell voltage of 1.2V. In an embodiment, the electrochemical cells provided herein have a nominal cell voltage of 1.5V. In an embodiment, the electrochemical cells provided herein have a nominal cell voltage of 1.7V. In an embodiment, the electrochemical cells provided herein have a nominal cell voltage of 3.6V. In certain embodiments, the electrochemical cells are of dimensions compliant with the recommendations of the International Electrochemical Commission or American National Standards Institute. In certain embodiments, the electrochemical cell is AAA cell. In some embodiments, the electrochemical cell is a AA cell. In some embodiments, the electrochemical cells are one or more of C cell, D cell, Lantern cell, PP3 cell, ½AA cell, AAAA cell, A cell, B cell, F cell, N cell, No. 6 cell, Sub-C cell, A23 cell, A27 cell, 4SR44 cell, 523 cell, 531 cell, J cell, PP1 cell, PP3 cell, PP6 cell, PP7 cell, PP8 cell, PP9 cell, PP10 cell, PP11 cell, CR123A cell, CR2 cell, 2CR5 cell, CR-P2 cell, CR-V3 cell, CR11108 cell, CR3032 cell, CR2477 cell, CR2450 cell, CR2430 cell, CR2354 cell, CR2330 cell, CR2032 cell, CR2025 cell, CR927 cell, CR1025 cell.

In certain embodiments described herein, “transformation of an energy storage device” comprises transforming said device from a substantially uncharged state to a substantially charged state or from a substantially charged state to a substantially uncharged state.

In some embodiments, a substantially charged state is one wherein the energy storage device is charged to about 50% of its capacity. In an embodiment, the substantially charged state is one wherein the energy storage device is charged to about 60% of its capacity. In some embodiments, a substantially charged state is one wherein the energy storage device is charged to about 65% of its capacity. In some embodiments, a substantially charged state is one wherein the energy storage device is charged to about 70% of its capacity. In some embodiments, a substantially charged state is one wherein the energy storage device is charged to about 75% of its capacity. In some embodiments, a substantially charged state is one wherein the energy storage device is charged to about 80% of its capacity. In some embodiments, a substantially charged state is one wherein the energy storage device is charged to about 85% of its capacity. In some embodiments, a substantially charged state is one wherein the energy storage device is charged to about 90% of its capacity. In some embodiments, a substantially charged state is one wherein the energy storage device is charged to about 95% of its capacity. In some embodiments, a substantially charged state is one wherein the energy storage device is charged to about 99% of its capacity. In some embodiments, a substantially charged state is one wherein the energy storage device is charged to about 100% of its capacity.

In some embodiments, a substantially uncharged state is one wherein the energy storage device has discharged more than about 50% of its energy storage capacity. In some embodiments, a substantially uncharged state is one wherein the energy storage device has discharged more than about 55% of its energy storage capacity. In some embodiments, a substantially uncharged state is one wherein the energy storage device has discharged more than about 60% of its energy storage capacity. In some embodiments, a substantially uncharged state is one wherein the energy storage device has discharged more than about 65% of its energy storage capacity. In some embodiments, a substantially uncharged state is one wherein the energy storage device has discharged more than about 70% of its energy storage capacity. In some embodiments, a substantially uncharged state is one wherein the energy storage device has discharged more than about 75% of its energy storage capacity. In some embodiments, a substantially uncharged state is one wherein the energy storage device has discharged more than about 80% of its energy storage capacity. In some embodiments, a substantially uncharged state is one wherein the energy storage device has discharged more than about 85% of its energy storage capacity. In some embodiments, a substantially uncharged state is one wherein the energy storage device has discharged more than about 90% of its energy storage capacity. In some embodiments, a substantially uncharged state is one wherein the energy storage device has discharged more than about 95% of its energy storage capacity. In some embodiments, a substantially uncharged state is one wherein the energy storage device has discharged about 100% of its energy storage capacity.

In certain embodiments described herein, “transformation of an energy storage device” comprises transforming said device into component materials. To transform the energy storage devices into component parts, the devices are first sorted based on the electrochemical cell type of each device. For instance, energy storage devices comprising cadmium are collected in a group; devices comprising lead are collected in a group etc. In certain embodiments, the transformation into isolated component materials is initiated by removing combustible material, such as but not restricted to plastics, paper and insulation, with an oxidizer. In certain embodiments, the oxidizer is a gas-fired thermal oxidizer. In certain embodiments, a scrubber is used to eliminate polluting particles created by the oxidation process, before releasing into the atmosphere. After this, the energy storage devices are heated until the metals that constitute said energy storage devices liquefy. In certain embodiments, the devices are chopped into small pieces prior to heating. In some embodiments, non-metallic substances are burned off; leaving a slag, and said slag is removed by a slag arm in certain embodiments. The metal alloys settle according to weight and are skimmed off while in liquid form.

For instance, cadmium is relatively light and vaporizes at high temperatures. For energy storage devices comprising cadmium, a fan blows the cadmium vapor into a cooled receptacle. In certain embodiments, the receptacle is the surface of a tube cooled internally with water mist. The vapors condense on the cool surface to produce cadmium. In some embodiments, the cadmium is of greater than 90% purity. In some embodiments, the cadmium is of greater than 95% purity. In some embodiments, the cadmium is of greater than 99% purity. In some embodiments, the cadmium is of greater than 99.5% purity.

In certain embodiments, the metals are not isolated any further than the alloy stage. In some embodiments, the metal alloys are transported to metal recovery plants where they are used to obtain isolated component metal such as but not limited to nickel, chromium and iron for stainless steel and other high-end products.

### Transformation Unit

A “transformation unit” is at least one device used for transformation of the energy storage devices, said transformation selected from: transformation of substantially uncharged energy storage devices to a substantially charged state by providing a sufficient amount of energy; and transformation of energy storage devices into component materials. In some embodiments, the transformation unit is a charging unit.

A “charging unit” is a device used to put energy into an energy storage device such as a secondary electrochemical cell by forcing an electric current through it. The charge current depends upon the technology and capacity of the device being charged.

In certain embodiments is provided a charging unit that works by supplying a constant DC or pulsed DC power source to an energy storage device that is being charged. In some embodiments the charging unit does not alter its output based on time or the extent of charge present in the energy storage device. In certain embodiments is provided an AC-powered charging unit. In an embodiment, the AC-powered charging unit has a ripple current that is under 5 amps.

In certain embodiments is provided a charging unit that is a trickle charging unit. Trickle charging means charging a rechargeable energy storage device at a similar rate as its self-discharging rate, thus maintaining the device at a substantially charged state. Some rechargeable electrochemical cells such as, but not restricted to nickel-cadmium cells or nickel metal hydride cells, have a moderate rate of self-discharge, meaning they gradually lose their charge even if they are not used in a device. In certain embodiments, the trickle charging unit also comprises a regulator to ensure that the charge rate is not greater than the level of self-discharge in order to prevent overcharging and possible damage or leakage.

In certain embodiments is provided a charging unit that is a float charging unit which is a trickle charging unit with circuitry to prevent overcharging. In certain embodiments, the float charging unit senses when the energy storage device voltage is at the appropriate float level and temporarily ceases charging; it maintains the charge current at zero or a very minimal level until it senses that the output voltage from the energy storage device has fallen, and then resumes charging.

In certain embodiments, the charging unit described herein further comprises a timer, which terminates the charging after a pre-determined time. In certain embodiments is provided a “smart charging unit” for use with a “smart energy storage device.” In certain embodiments, a smart energy storage device is one comprising an electronic device or “chip” that can communicate with a smart charging unit about the energy storage device characteristics and condition. A smart energy storage device generally requires a smart charging unit it can communicate with. A smart charging unit is defined as a charging unit that can respond to the condition of an energy storage device, and modify its charging actions accordingly. Some smart charging are designed to transform smart energy storage devices from a substantially uncharged state to a substantially charged state. Some smart charging units are designed to transform from a substantially uncharged state to a substantially charged state, any energy storage device that lacks internal electronic circuitry. The output current of a smart charging unit depends upon the state of the energy storage device. Charging is terminated when a combination of the voltage, temperature and/or time indicates that the energy storage device is fully transformed to a charged state.

In certain embodiments, for Ni—Cd and NiMH electrochemical cells, the voltage across the cell increases slowly during the charging process, until the cell is fully transformed. After that, the voltage decreases, this in some embodiments indicates to a charging unit that the electrochemical cell is fully transformed to a substantially charged state. Such charging units are ΔV, “delta-V,” or sometimes “delta peak”, charging units.

In certain embodiments, the charging unit is a fast charging unit. In some embodiments, the fast charging unit makes use of control circuitry in the energy storage devices being charged to rapidly charge said storage devices without damage. In certain embodiments, the charging units have a cooling fan to help keep the temperature of the cells under control.

In certain embodiments, the charging unit uses pulse technology in which a series of voltage or current pulses is fed to the energy storage device. The DC pulses have a strictly controlled rise time, pulse width, pulse repetition rate (frequency) and amplitude. In certain embodiments, the charging units use pulses to check the current state of the energy storage device when first connected, and then use constant current charging during fast charging, then use pulse charging as a kind of trickle charging to maintain the charge. Some charging units use “negative pulse charging”, also called “reflex charging” or “burp charging”. Such charging units use both positive and brief negative current pulses. In certain embodiments, a charging unit useful in a system and/or method described herein is a constant current charging unit.

In certain embodiments, the charging unit is an inductive charging unit that uses electromagnetic field to transfer energy to at least one energy storage device. The charging unit sends energy through inductive coupling to a receptacle which stores the energy in the energy storage devices. In certain embodiments, the receptacle is a removable receptacle placed in a distribution unit to dispense said energy storage devices.

In certain embodiments, the charging unit is a solar charging unit that converts light energy into electricity. In certain embodiments, solar charging units are used for trickle charging. In certain embodiments, solar charging units are used to completely transform the energy storage device from a substantially uncharged state to a substantially charged state. In certain embodiments, the charging unit comprises turbines that convert kinetic energy into mechanical energy which is used to produce electricity. In certain embodiments, the turbines use kinetic energy from the wind. In some embodiments, the turbines use kinetic energy from sea-waves. In an embodiment, the electricity provided by the charging unit to the energy storage device is obtained from a hydroelectric or wind source.

In some embodiments, the charging unit can simultaneously charge at least 10 energy storage devices. In an embodiment is a charging unit that can simultaneously charge at least 20 energy storage devices. In certain embodiments are charging units that can simultaneously charge at least 50 energy storage devices. In an embodiment provided is a charging unit that can simultaneously charge at least 100 energy storage devices. In some embodiments are charging units that can simultaneously charge at least 1000 energy storage devices. In some embodiments, are charging units that can simultaneously charge at least 10000 energy storage devices. In certain embodiments are charging units that can charge at least 100000 energy storage devices. In certain embodiments, a plurality of charging units are simultaneously provided in a system described herein. In a further embodiment, at least 5 charging units are simultaneously provided in a system described herein. In certain embodiments, 10 charging units are deployed simultaneously to charge a high plurality of energy storage devices. In an embodiment, 50 charging units are provided. In a further embodiment, at least 100 charging units are provided. In some embodiments, at least 1000 charging units that can simultaneously charge between 10 and 100000 energy storage devices are provided in systems described herein. In certain embodiments, at least one charging unit is contained within a distribution unit described herein.

### Processing Device

The systems, programs, platforms, and methods described herein include a processing device, or use of the same. In certain embodiments described herein, the processing device is useful to manage distribution and transformation of energy storage devices. In certain embodiments, the processing device includes one or more hardware central processing units (CPU) that carry out the device's functions. In some embodiments, the processing device further comprises an operating system configured to perform executable instructions, a storage device, a display, an input device, a scanning device, and optionally a sound output device. In some embodiments, the digital processing device is optionally connected to the Internet such that it accesses the World Wide Web. In other embodiments, the processing device is optionally connected to an intranet. In other embodiments, the processing device is optionally connected to a data storage device.

In accordance with the description herein, suitable processing devices include, by way of non-limiting examples, server computers, desktop computers, laptop computers, notebook computers, sub-notebook computers, netbook computers, netpad computers, set-top computers, handheld computers, Internet appliances, mobile smart phones, tablet computers, personal digital assistants, and video game consoles. Those of skill in the art will recognize that many smart phones are suitable for use in the system described herein. Those of skill in the art will also recognize that select televisions and select digital music players with computer network connectivity are suitable for use in the system described herein. Suitable tablet computers include those with booklet, slate, and convertible configurations, known to those of skill in the art.

In some embodiments, the processing device described herein includes an operating system configured to perform executable instructions. The operating system is, for example, software, including programs and data, which manages the device's hardware and provides services for execution of applications, performed using the device. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®.

In certain embodiments the processing device includes a storage and/or memory device. The storage and/or memory device is one or more physical apparatuses used to store data or programs on a temporary or permanent basis. In some embodiments, the memory device is volatile memory and requires power to maintain stored information. In some embodiments, the memory device is non-volatile memory and retains stored information when the digital processing device is not powered. In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In certain embodiments the processing device includes a display to send visual information to a user. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, an OLED display is a passive-matrix OLED (PMOLED) or active-matrix OLED (AMOLED) display. In some embodiments, the display is a plasma display. In other embodiments, the display is a video projector. In still further embodiments, the display is a combination of devices such as those disclosed herein.

In certain embodiments, the processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera to capture motion or visual input. In still further embodiments, the input device is a combination of devices such as those disclosed herein.

In certain embodiments, a processing device described herein is useful to manage distribution of energy storage devices in a distribution unit. In certain embodiments, said distribution comprises at least one of receiving energy storage devices from a sender user; dispensing substantially charged energy storage devices to a recipient user, or both. In certain embodiments, a processing device described herein is useful to manage transformation of energy storage devices to substantially charged energy storage devices. In certain embodiments, the processing device is useful to manage transformation of energy storage devices to a substantially charged state, wherein said transformation is performed by use of at least one charging unit. In certain embodiments, said at least one charging unit is contained within the distribution unit. In certain embodiments, a processing device described herein is useful to manage transformation of substantially uncharged energy storage device into its component materials. In certain embodiments, a processing device described herein is useful to manage transformation, storage, inventory, and dispensation of energy storage devices.

### Computer Network

The systems, programs, platforms, and methods disclosed herein include a processing device that is optionally connected to a computer network, or use of the same. A computer network is a collection of computers and/or devices interconnected by communications channels that facilitate communication and sharing resources among users, computers, or components of the network itself. In view of the disclosure provided herein, the computer network is created by techniques known to those of skill in the art using hardware, firmware, and software known to the art. In some embodiments, the computer network is a private network such as an intranet. In some embodiments, the computer network is the Internet. In further embodiments, the Internet provides access to the World Wide Web and the computer program is provided to the digital processing device via the Web. In still further embodiments, the Internet provides access to the World Wide Web and the computer program is provided to the digital processing device via cloud computing. In other embodiments, the computer network comprises data storage devices including, by way of non-limiting examples, CD-ROMs, DVDs, flash memory devices, magnetic disk drives, magnetic tapes drives, optical disk drives, and cloud computing based storage. In further embodiments, the computer program is provided to the digital processing device via a data storage device.

### Computer Program Instructions

The systems, programs, platforms, and methods described herein include instructions provided by means of a computer program, or use of the same. The computer program includes a sequence of instructions, executable in the processing device's CPU, written to perform a specified task. In light of the disclosure provided herein, those of skill in the art will recognize that the computer program, in various embodiments, utilizes one or more software frameworks and one or more database systems. In some embodiments, the computer program is created upon a software framework such as Microsoft®.NET or Ruby and Rails (RoR). In some embodiments, the computer program utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®.

Those of skill in the art will also recognize that the computer program, in various embodiments, is written in one or more versions of one or more languages. In certain embodiments, the computer program is written in an Object Oriented language. In certain embodiments, the computer program is written in one or more markup languages, presentation definition languages, client-side scripting languages, server-side coding languages, database query languages, or combinations thereof. In some embodiments, the computer program is written to some extent in a markup language such as Hypertext Markup Language (HTML), Extensible Hypertext Markup Language (XHTML), or eXtensible Markup Language (XML). In some embodiments, the computer program is written to some extent in a presentation definition language such as Cascading Style Sheets (CSS). In some embodiments, the computer program is written to some extent in a client-side scripting language such as Asynchronous Javascript and XML (AJAX), Flash® Actionscript, Javascript, or Silverlight®. In some embodiments, the computer program is written to some extent in a server-side coding language such as Active Server Pages (ASP), ColdFusion®, Perl, Java™, JavaServer Pages (JSP), Hypertext Preprocessor (PHP), Python™, Ruby, or Tcl. In some embodiments, the computer program is written to some extent in a database query language such as Structured Query Language (SQL). In some embodiments, the computer program is written to some extent in a programming language such as C, C++ or C#.

In certain embodiments, computer programming instructions are provided in electronic digital memory in a processing device described herein, said instructions useful to manage distribution of energy storage devices, said distribution comprising at least one of receiving substantially uncharged energy storage devices from a sender user; dispensing substantially charged energy storage devices to a recipient user, or both. In certain embodiments, are provided computer program instructions to manage storage, and inventory of energy storage devices in a dispensation unit. In certain embodiments, computer programming instructions are provided in electronic digital memory in a processing device described herein, said instructions useful to manage transformation of substantially uncharged energy storage devices to substantially charged energy storage devices by means of a charging unit. In certain embodiments, the charging unit is contained within said distribution unit. In certain embodiments, computer programming instructions are provided in electronic digital memory in a processing device described herein, said instructions useful to manage transformation of substantially uncharged energy storage device into its component materials. In an embodiment is provided a sequence of computer program instructions as described herein, wherein said sequence of computer program instructions is stored in an electronic digital memory in a processing device, and wherein said sequence of computer program instructions when executed causes at least one of receipt, transformation, inventory, storage, and dispensation of energy storage devices.

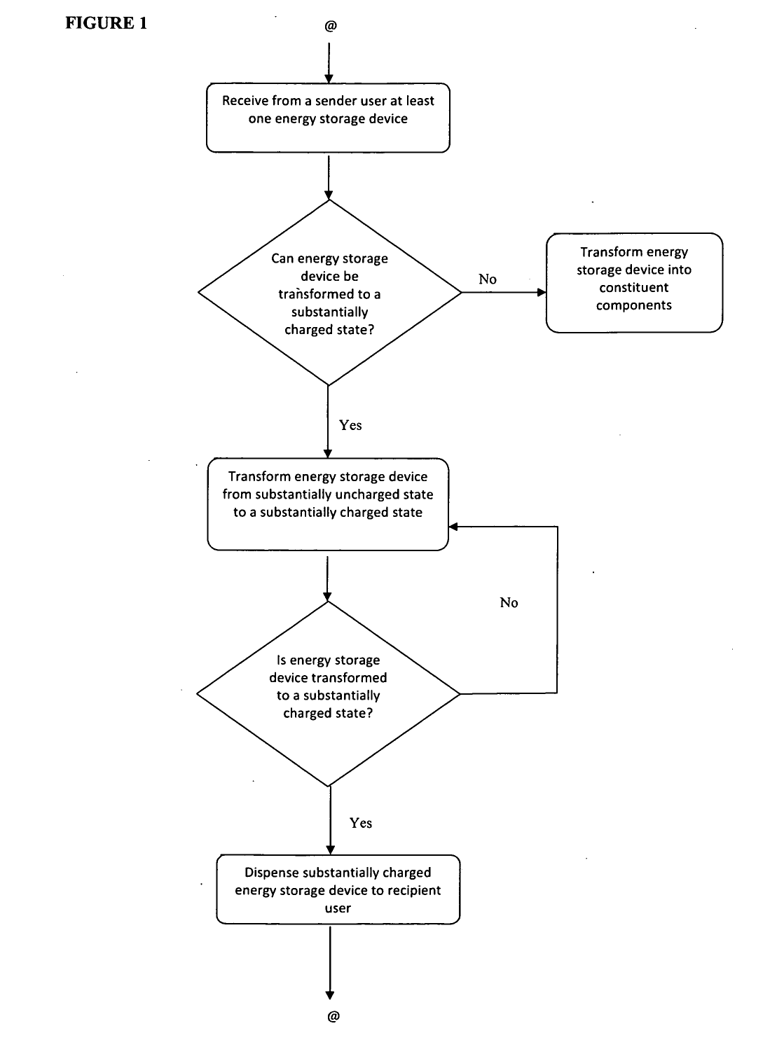

In certain embodiments, are provided computer program instructions for managing steps such as receipt, transformation, and initiation of delivery of energy storage device as described in FIG. 1. In some embodiments are provided computer program instructions for managing receipt of energy storage devices from sender users, verifying if said energy storage devices can be transformed to a substantially charged state, managing transformation of said energy storage devices into substantially charged state or into constituent components (FIG. 1), verifying the transformation of the energy storage devices, and dispensing appropriate charged energy storage devices to recipient users.

### Modules

The systems, programs, platforms, and methods described herein include software, server, and database modules, or use of the same. In view of the disclosure provided herein, these modules are created by techniques known to those of skill in the art using machines, software, and languages known to the art. In some embodiments, the modules are in a single computer program. In other embodiments, the modules are in more than one computer program. In some embodiments, the modules are hosted on one machine. In other embodiments, the modules are hosted on more than one machine. In some embodiments, the modules are hosted on one or more machines in one location. In other embodiments, the modules are hosted on one or more machines in more than one location. Further described herein is the formatting of data. In some embodiments, the data files described herein are formatted in a data serialization format known to those in the art including, by way of non-limiting examples, tab-separated values, comma-separated values, character-separated values, delimiter-separated values, XML, JSON, BSON, and YAML.

### Distribution Unit

Provided herein is a distribution unit (such as, but not restricted to the units in FIG. 3, and FIG. 4) for receiving, and dispensing energy storage devices (2), said unit comprising a receiver panel (100) useful to receive at least one energy storage device from a sender user; a selection panel (200) that enables a recipient user to select size, type and number of energy storage devices to be dispensed; a transaction panel (300) useful to process payment from said recipient user; a dispensation panel (400) useful to dispense to said recipient user, substantially charged energy storage devices as selected by the recipient user; and a control panel (500), said panel useful at least for restocking and organizing energy storage devices within said distribution unit.

In certain embodiments, the distribution unit (1) further comprises a charging unit (3) for transforming energy storage devices (2) from a substantially uncharged state to a substantially charged state. In some embodiments, transformation of the energy storage devices is performed by providing electricity in an amount sufficient to transform said energy storage devices (2) from a substantially uncharged state to a substantially charged state. In a further embodiment, the charging unit can simultaneously charge a plurality of energy storage devices by transforming said devices from a substantially uncharged state to a substantially charged state. In an embodiment, the charging unit maintains substantially charged energy storage devices in said substantially charged state till said devices are dispensed to a recipient user. In an embodiment, the charging unit can simultaneously charge at least 10 energy storage devices. In some embodiments, the charging unit can simultaneously charge at least 20 energy storage devices. In some embodiments, the charging unit can simultaneously charge at least 50 energy storage devices. In an embodiment, the charging unit can simultaneously charge at least 100 energy storage devices. In certain embodiments, the charging unit can simultaneously charge at least 1000 energy storage devices. In some embodiments, are charging units that can simultaneously charge at least 10000 energy storage devices. In certain embodiments are charging units that can charge at least 100000 energy storage devices.

In certain embodiments, the charging unit (3) regulates the supply of energy to the energy storage devices. In further embodiments, the regulation further comprises prevention of overcharging of charged energy storage devices. In some embodiments is a charging unit (3) wherein at least some of the electricity is obtained from a renewable source. In an embodiment, all of the electricity is obtained from a renewable source. In some embodiments, the renewable source of electricity is solar. In an embodiment, the renewable source of electricity is biomass, biofuel, geothermal, tidal, hydroelectric, wind, solar or combinations thereof. In certain embodiments is provided a distribution unit (1) which further comprises a charging unit (3) that regulates the supply of electricity so as to minimize charging during peak hours. In some embodiments of the distribution unit described herein, the energy storage device (2) is an electrochemical cell. In some embodiments, the electrochemical cell is rechargeable. In certain further embodiments, the electrochemical cells are not traction batteries. In some specific embodiments, the electrochemical cells are not electric vehicle batteries.

Provided is a distribution unit as described herein, wherein said distribution unit further comprises at least one panel for secure placement of energy storage devices. In some embodiments, the at least one panel for secure placement of energy storage devices comprises a lining comprising an insulator material such that said material helps avoid the dissipation of charge in the energy storage device. In certain embodiments, the at least one panel for secure placement of energy storage devices can be detached from the distribution unit. In some embodiments, the at least one panel for secure placement of energy storage devices can be connected to a source of energy that provides an amount of energy to transform said at least one energy storage device from a substantially uncharged state to a substantially charged state.

In certain embodiments provided is a distribution unit (1) for receiving energy storage devices (2), said unit comprising: a receiver panel (100) useful to receive at least one energy storage device (2) from a sender user; a selection panel (200) that enables said sender user to select transaction options; a transaction panel (300) useful to process said transaction; and a control panel (500), said panel useful at least for removing energy storage devices within said distribution unit.

Provided is a distribution unit (1) as described herein, wherein said distribution unit comprises a selection panel (200) that comprises at least one display screen. In some embodiments, the display screen is a touchscreen. In an embodiment, the selection panel comprises at least one keyboard.

Provided is a distribution unit as described herein, wherein said distribution unit (1) comprises a transaction panel (300) that comprises at least one bill acceptor and at least one coin acceptor to accept currency bills and coins from a recipient user. In certain embodiments, the bill acceptor further comprises a mechanism to identify the bill and return any unacceptable bill. In some embodiments, the coin acceptor further comprises a mechanism to identify the coin and return any unacceptable coins. In an embodiment, the transaction panel further comprises a change panel (600) to return appropriate change to the recipient user. In another embodiment, the transaction panel comprises at least one panel to facilitate an electronic transaction. In a further embodiment, the panel to facilitate electronic transaction comprises a magnetic strip reader. In certain embodiments, the panel to facilitate electronic transaction comprises a contactless card reader. In an embodiment, the contactless card is a RFID card. In some embodiments, the contactless card is a resonance inductive coupling powered card. In another embodiment, the contactless card is ISO/IEC 14443 card.

Provided is a distribution unit (1) as described herein, wherein said distribution unit holds a plurality of multiple types of energy storage devices (2). In certain embodiments, the distribution unit further comprising a mechanism to issue an alert. In some embodiments, the alert mechanism is triggered when at least one energy storage device cannot be transformed to a substantially charged state. In certain embodiments, the alert is activated when a majority of energy storage devices are removed from said device. In an embodiment, the alert is activated when a payment cannot be processed. In some embodiments, the alert is activated when the device is unable to dispense appropriate change in the change panel.

Provided is a distribution unit (1) as described herein, wherein said distribution unit comprises a control panel (500) providing access for restocking and servicing. In certain embodiments, the control panel further comprises a key-less locking panel.

Provided is a distribution unit as described herein, wherein said distribution unit further comprises a scanner that can read a barcode. In certain embodiments, the barcode is a matrix barcode. In a further embodiment, the matrix barcode is a quick response code.

In certain embodiments is provided a distribution unit (1) described herein further comprising a charging unit (3) described herein (such as, but not restricted to the unit shown in FIG. 4). In an embodiment, the energy storage devices (2) received via the receiver panel (200) are sorted and organized in the optimum orientation for charging by a sorter (700). In certain embodiments, the energy storage devices (2) sorted by a sorter (700) are then directed into the appropriate charging unit (such as 1000 and 2000) by means of entry channels (such as 1050, and 2050). The appropriate charging unit for an energy storage device is determined by the size, and dimensions of the energy storage device. Substantially charged energy storage devices are provided for dispensation from the charging unit to the distribution unit by means of an exit channel (such as 1500). Energy storage devices that cannot be transformed into substantially charged state are discarded from the charger by means of discard channels (such as 1100 and 2100). The discarded energy storage devices are collected in a bin (3000) which can be accessed by means of the control panel (500). In certain embodiments, the discarded energy storage devices are transformed into component materials as described herein.

Provided is a method of using a distribution unit described herein for efficiently recycling energy storage devices, said method comprising: receiving at least one energy storage device in a substantially uncharged state; transforming said energy storage device from a substantially uncharged state to a substantially charged state; dispensing said substantially charged energy storage device to a user. In certain embodiments, the energy storage device is an electrochemical cell. In a further embodiment, the electrochemical cell is rechargeable.

1. A system for managing distribution and transformation of energy storage devices, wherein said system comprises:
at least one distribution unit to: receive energy storage devices from a sender user, dispense substantially charged energy storage devices to a recipient user, or both;
at least one transformation unit for transformation of energy storage devices, said transformation selected from:
transformation of substantially uncharged energy storage devices to a substantially charged state by providing a sufficient amount of electricity; and
transformation of energy storage devices into component materials;
at least one processing unit which is optionally a computer; and
at least one sequence of program instructions stored in an electronic digital memory in said processing unit, which when executed cause at least one step selected from transformation, inventory, storage, and dispensation of energy storage devices.

2. A system as described in claim 1, wherein said at least one of said transformation unit and said processing unit are contained within said distribution unit.

3. (canceled)

4. (canceled)

5. (canceled)

6. (canceled)

7. A system as described in claim 1 wherein the transformation unit transforms substantially uncharged energy storage devices to a substantially charged state, and maintains substantially charged energy storage devices in said substantially charged state.

8. A system as described in claim 1, wherein the transformation unit can simultaneously charge from about 10 to about 1000 energy storage devices.

9. (canceled)

10. (canceled)

11. (canceled)

12. (canceled)

13. A system as described in claim 1, wherein said system comprises a mechanism for the regulation of electricity to the energy storage devices, said regulation comprising at least one of: preventing overcharging of charged energy storage devices, and minimizing charging during peak hours.

14. (canceled)

15. A system as described in claim 1 wherein at least some of said electricity is obtained from a renewable source selected from solar, biomass, biofuel, geothermal, tidal, hydroelectric, wind and combinations thereof.

16. (canceled)

17. (canceled)

18. (canceled)

19. (canceled)

20. A system as described in claim 1 wherein said energy storage device is an electrochemical cell selected from a rechargeable cell and a non-rechargeable cell, and wherein said electrochemical cell is not an automobile traction battery.

21. (canceled)

22. (canceled)

23. A system as described in claim 1 wherein said charging unit is separate from said distribution unit, and wherein said energy storage devices are transported between said distribution unit and said charging unit by means of a delivery service.

24. (canceled)

25. (canceled)

26. (canceled)

27. (canceled)

28. (canceled)

29. (canceled)

30. A system as described in claim 1, wherein said distribution unit comprises:
a receiver panel to receive at least one energy storage device from a sender user;
a selection panel that enables a recipient user to select size, type and number of energy storage devices to be dispensed;
a transaction panel to process payment from said recipient user;
a dispensation panel to dispense to said recipient user, substantially charged energy storage devices as selected by the recipient user; and
a control panel for at least restocking and organizing energy storage devices within said distribution unit.

31. A computer-implemented method of managing distribution and transformation of energy storage devices, wherein said method comprises:
receiving substantially uncharged energy storage devices;
transforming energy storage devices from a substantially uncharged state to a substantially charged state by providing a sufficient amount of electricity or transforming the energy storage devices into component materials or transforming said energy storage devices into isolated component materials;
optionally maintaining substantially charged energy storage devices in said substantially charged state and optionally preventing overcharging of substantially charged energy storage devices;
transacting payment from a recipient user for substantially charged energy storage devices selected by said user;
dispensing charged energy storage devices to said recipient user;
utilizing at least one sequence of computer program instructions stored in an electronic digital memory in a computer to manage at least one step selected from organization, transformation, inventory, storage, payment transaction and dispensation of energy storage devices.

32. (canceled)

33. (canceled)

34. (canceled)

35. (canceled)

36. (canceled)

37. A distribution unit for receiving, and optionally dispensing energy storage devices, said unit comprising:
a receiver panel to receive at least one energy storage device from a sender user;
a selection panel that enables a recipient user to select size, type and number of energy storage devices to be dispensed;
a transaction panel to process payment from said recipient user;
optionally a dispensation panel to dispense to said recipient user, substantially charged energy storage devices as selected by the recipient user;
a control panel for at least restocking and organizing energy storage devices within said distribution unit; and
optionally comprising a transformation unit for transformation of a plurality of energy storage devices to a substantially charged state by providing a sufficient amount of electricity, wherein said transformation unit optionally maintains substantially charged energy storage devices in said substantially charged state till said devices are dispensed to a recipient user and wherein said transformation unit optionally regulates the supply of electricity to the energy storage devices by preventing overcharging of charged energy storage devices and/or minimizing charging during peak hours.

38. (canceled)

39. (canceled)

40. (canceled)

41. (canceled)

42. A distribution unit as described in claim 37 wherein the charging unit can simultaneously charge from at least about 10 energy storage devices to at least about 1000 energy storage devices.

43. (canceled)

44. (canceled)

45. (canceled)

46. (canceled)

47. (canceled)

48. (canceled)

49. A distribution unit as described in claim 37, wherein at least some of said electricity is obtained from a renewable source selected from solar, biomass, biofuel, geothermal, tidal, hydroelectric, wind and combinations thereof.

50. (canceled)

51. (canceled)

52. (canceled)

53. (canceled)

54. A distribution unit as described in claim 37, wherein said distribution unit comprises at least one panel for secure placement of energy storage devices, said panel optionally comprising a lining comprising an insulator material such that said material reduces the dissipation of charge in the energy storage device, wherein said panel is optionally detachable from said distribution unit, and wherein said panel can optionally be connected to a source of energy that provides an amount of energy to transform said at least one energy storage device from a substantially uncharged state to a substantially charged state.

55. (canceled)

56. (canceled)

57. (canceled)

58. A distribution unit as described in claim 37 wherein said energy storage device is an electrochemical cell selected from a rechargeable cell and a non-rechargable cell, and wherein said electrochemical cell is not an automobile traction battery.

59. (canceled)

60. (canceled)

61. (canceled)

62. (canceled)

63. A distribution unit as described in claim 37 wherein said selection panel optionally comprises at least one display screen optionally comprising a touchscreen, wherein said selection panel optionally comprises at least one keyboard.

64. (canceled)

65. (canceled)

66. A distribution unit as described in claim 37 wherein said transaction panel optionally comprises at least one of:
a bill acceptor optionally comprising a mechanism to identify the bill and return unacceptable bills and a coin acceptor optionally comprising a mechanism to identify the coin and return unacceptable coins;
a change panel to return appropriate change to the recipient user; and
a panel to facilitate an electronic transaction.

67. (canceled)

68. (canceled)

69. (canceled)

70. (canceled)

71. A distribution unit as described in claim 66 wherein said panel to facilitate electronic transaction optionally comprises at least one of: a magnetic strip reader and a contactless card reader, wherein said contactless card reader is optionally at least one of a RFID card, a resonance inductive coupling powered card, and an ISO/IEC 14443 card.

72. (canceled)

73. (canceled)

74. (canceled)

75. (canceled)

76. (canceled)

77. (canceled)

78. A distribution unit as described in claim 66 comprising a mechanism to issue an alert, wherein said alert is optionally activated in response to at least one of the following:
when at least one energy storage device cannot be transformed to a substantially charged state;
when a majority of energy storage devices are removed from said device;
when a payment cannot be processed;
when the device is unable to dispense appropriate change in the change panel.

79. (canceled)

80. (canceled)

81. (canceled)

82. (canceled)

83. A distribution unit as described in claim 37 wherein said distribution unit can be accessed for restocking, and servicing by means of said control panel and wherein said control panel optionally comprises a key-less locking panel.

84. (canceled)

85. A distribution unit as described in claim 37, comprising a scanner that can read a barcode, wherein said barcode is optionally a matrix barcode which is optionally a quick-response code.

86. (canceled)

87. (canceled)

88. A method of using a distribution unit described in claim 37 for efficiently recycling energy storage devices comprising:
receiving at least one energy storage device in a substantially uncharged state;
transforming said energy storage device from a substantially uncharged state to a substantially charged state;
dispensing said substantially charged energy storage device to a user,
wherein said energy storage device is an electrochemical cell selected from a rechargeable cell and a non-rechargable cell, and wherein said electrochemical cell is not an automobile traction battery.

89. (canceled)

90. (canceled)

91. (canceled)
